(19) United States
(12) Patent Application Publication
(10) Pub. No.: US 2009/0136246 A1
(43) Pub. Date: May 28, 2009

(54) IMAGE FORMING APPARATUS HAVING PAPER TYPE DETECTION SECTION AND PAPER TYPE CONFIRMATION METHOD OF THE SAME

(75) Inventor: Reiji MURAKAMI, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/274,663

(22) Filed: Nov. 20, 2008

Related U.S. Application Data
(60) Provisional application No. 60/990,097, filed on Nov. 26, 2007.

(51) Int. Cl. G03G 15/00

(52) U.S. Cl. 399/45; 399/81

(57) ABSTRACT

An image forming apparatus having a paper type detection section according to an embodiment of the present invention includes a paper type and paper thickness storage section to store ranges of paper thicknesses correspondingly to a plurality of paper types, a paper thickness detection section to detect a thickness of a sheet on which a formed image is printed, and a paper thickness comparison and determination section to feed, when a specific paper type is selected, a sheet of the paper type to the paper thickness detection section and to determine whether the measured paper thickness is within the range of paper thickness stored in the paper type and paper thickness storage section and corresponding to the paper type, and when the paper thickness comparison and determination section determines that the measured paper thickness is outside the range of the selected paper type, a warning to that effect is issued.

### CROSS-REFERENCE TO RELATED APPLICATION

The present invention is based upon the benefit of priority from U.S. Provisional Application No. 60/990,097, filed Nov. 26, 2007. The contents of the provisional application are incorporated herein by reference.

### TECHNICAL FIELD

The present invention relates to an image forming apparatus, and particularly to an image forming apparatus having a paper type detection section and a paper type confirmation method in the image forming apparatus.

### BACKGROUND

Hitherto, in an image forming apparatus such as a multi-function color copier (MFP), the types of media on which color images or the like are printed are increased. Even if the print media are limited to sheets, various sheets different in thickness or the like are used.

Incidentally, the types of sheets are generally differentiated by basis weight (unit: g/m²) indicating the weight per an area, and for example, sheets of groups of 64 to 105, 106 to 163, 164 to 209, 210 to 256, and 257 to 300 are respectively called standard paper, thick paper 1, thick paper 2, thick paper 3 and thick paper 4. These basis weights are generally written on packages of sheets. When the user selects one of the groups of the written basis weights, a print condition corresponding to the type of the paper is automatically set. In general, it is desirable to change the print condition according to the basis weight.

Generally, the MFP includes a unit configured to cause the user to select the paper type by a button or an icon on a display, and when the paper type is selected by the icon or the like, setting is performed such that print conditions, such as a formation condition of a latent image, a formation condition of a visible image with toner, a transfer condition at transfer, and a fixing condition at fixing, are determined according to the paper type, and optimum printing is performed according to the selected paper type.

However, the user often cannot select a suitable paper type. In such a case, it is difficult to simply detect the basis weight. On the other hand, the basis weight can be calculated from the density of the sheet and the paper thickness. Although it is difficult to measure the density of the sheet, it is relatively easy to measure the paper thickness as compared with the measurement of the density. Then, an apparatus is known which detects the paper thickness in order to find the paper type or the like. Then, when the user can not determine the paper type, the paper thickness detecting apparatus is usually used to measure the paper thickness, and the paper type is estimated based thereon.

However, when the user selects the paper type as stated above, priority is given to the selection and various print conditions are set. Accordingly, even when the user erroneously selects the paper type, the print conditions corresponding to the selected paper type are set and printing is performed. In such a case, excellent printing cannot be performed.

With respect to this problem, JP-A-2003-29581 discloses an image forming apparatus including a control unit in which when a user inputs a paper type, and when a setting condition of the input paper type is different from paper type detection information obtained by a paper type detection unit, image formation to a recording sheet is not performed.

However, in this image forming apparatus, it is necessary to separately provide the paper type detection unit, and the cost is increased, and further, it is impossible to simply notify the user that an erroneous input of paper type is made.

### SUMMARY

The present invention is made in view of the above, and provides an image forming apparatus having a paper type detection section in which when a user erroneously selects a paper type, printing corresponding to the paper type is not performed, and a notice can be easily given to the user, and a paper type confirmation method of the same.

According to an aspect of the invention, an image forming apparatus having a paper type detection section includes a paper type and paper thickness storage section to store ranges of paper thicknesses corresponding to plural paper types, a paper thickness detection section to detect a thickness of a sheet on which a formed image is printed, and a paper thickness comparison and determination section to feed, when a specific paper type is selected, a sheet of the paper type to the paper thickness detection section and to determine whether a measured paper thickness is within the range of paper thickness stored in the paper type and paper thickness storage section and corresponding to the paper type, and when the paper thickness comparison and determination section determines that the measured paper thickness is outside the range of the selected paper type, a warning to that effect is issued.

In the invention, the paper thickness detection section used for paper type estimation when the paper type is not specified is used also when the paper type is specified, and the erroneous selection of paper type by the user is prevented.

### DESCRIPTION OF THE DRAWINGS

FIG. 1 is a perspective view showing a rough structure of a multi-function color copier (MFP) of an embodiment of the invention.

FIG. 2 is a view showing an example of a display screen of a touch panel display 103 of an operation panel 102 at a time of input of basis weight.

FIG. 3 is a view showing a whole electrical schematic structure of the embodiment.

FIG. 4 is a schematic structural view showing a process in which a sheet is fed, is printed and is discharged in the MFP of the embodiment of the invention.

FIG. 5 is a view showing a flowchart for explaining an operation of the MFP of the embodiment of the invention.

FIG. 6 is a view for explaining a relation between a conveyance drive mechanism and a paper thickness detection mechanism in the embodiment.

FIG. 7 is a view for explaining that a conveyance guide 301B and the like can be separated from a conveyance guide 301A and the like in a lateral direction in the embodiment.

FIG. 8 is a view for explaining that a conveyance driven roller and the like can be further separated from the conveyance guide 301B in the embodiment.

FIG. 9 is a view showing a structure of a paper thickness detection section 124 in the embodiment.

FIG. 10 is a perspective view showing a structure of a resistance change detection module 401, an arm 403 and a bearing 404 in the paper thickness detection section 124.

FIG. 11 is a view showing an example of output voltage of a voltage detection circuit 406 when a sheet enters the paper thickness detection section 124.

FIG. 12 is a view showing a relation among storage contents of a cassette sheet correspondence recognition section 122, a paper type and paper thickness storage section 122b and a paper thickness comparison and determination section 122c of the embodiment of the invention.

FIG. 13 is a view showing a structural example of the paper thickness comparison and determination section 122c of the embodiment of the invention.

### DETAILED DESCRIPTION

Hereinafter, an embodiment of an image forming apparatus of the invention will be described with reference to the drawings. In the following, it is premised that the image forming apparatus of the embodiment is a multi-function color copier and the description will be made.

In the embodiment described next, a paper thickness detection device to measure the thickness of a sheet is provided as a paper type detection device.

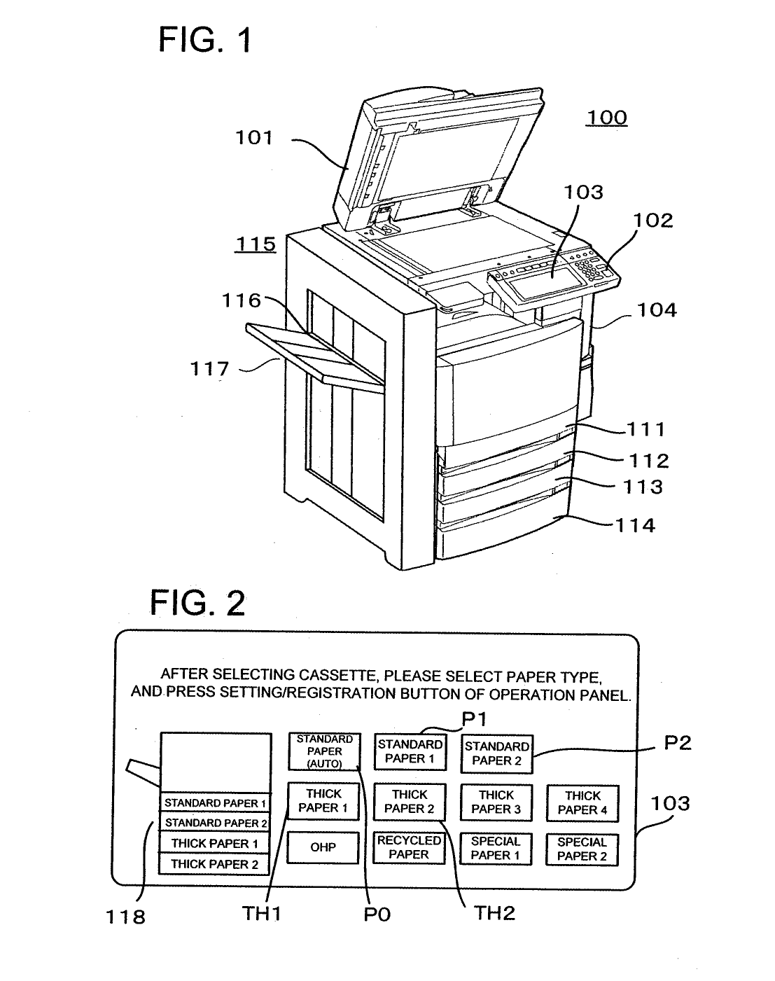

FIG. 1 is a perspective view showing an example of an outer appearance of the multi-function copier of the embodiment of the invention. An auto document feeder (ADF) 101 to automatically feed a sheet-like document one by one and used also as a document cover is openably and closably provided at an upper part of an apparatus main body 100. An operation panel 102 including various operation keys for instructing copy conditions and copy start, various indicators and the like is provided at an upper-front part of the apparatus main body 100. The operation panel 102 is also provided with various setting and registration buttons (not shown). A touch panel display 103 which displays various information to the user and can perform a specified input by user's touch when input is performed is provided at the side of the operation panel 102.

A handle 104 to enable the inside of the main body to be opened at a paper jam or the like is provided at the lower part of the operation panel 102 and on the front of the apparatus main body 100.

Paper feed cassettes 111, 112, 113 and 114 are attachably and detachably provided at the lower part of the apparatus main body 100. Sheets different in size and paper type are contained in the respective paper feed cassettes.

A finisher 115 contacts with the left side of the apparatus main body 100. In the apparatus main body 100, as described later, a latent image is formed, and a printed and fixed sheet is subjected to a process, such as aligning or stapling, by the finisher 115, and is discharged from a sheet discharge port 116. The sheet discharged from the sheet discharge port 116 is stacked on a stack tray 117.

When the setting and registration button of the operation panel 102 is pressed, a general setting registration screen is first displayed on the touch panel display 103, and when a sheet setting icon on this screen is touched, a sheet setting screen illustrated in FIG. 2 is displayed. A main body side surface icon 118 is displayed on the left of the screen, buttons P0, P1 and P2 of standard paper (auto), standard paper 1 and standard paper 2 are arranged and displayed at the first stage on the right side, and buttons of four kinds of thick papers, that is, thick paper 1, thick paper 2, thick paper 3 and thick paper 4 are displayed at the second stage. Buttons corresponding to the types of sheets other than the standard paper and the thick paper are displayed at the third stage.

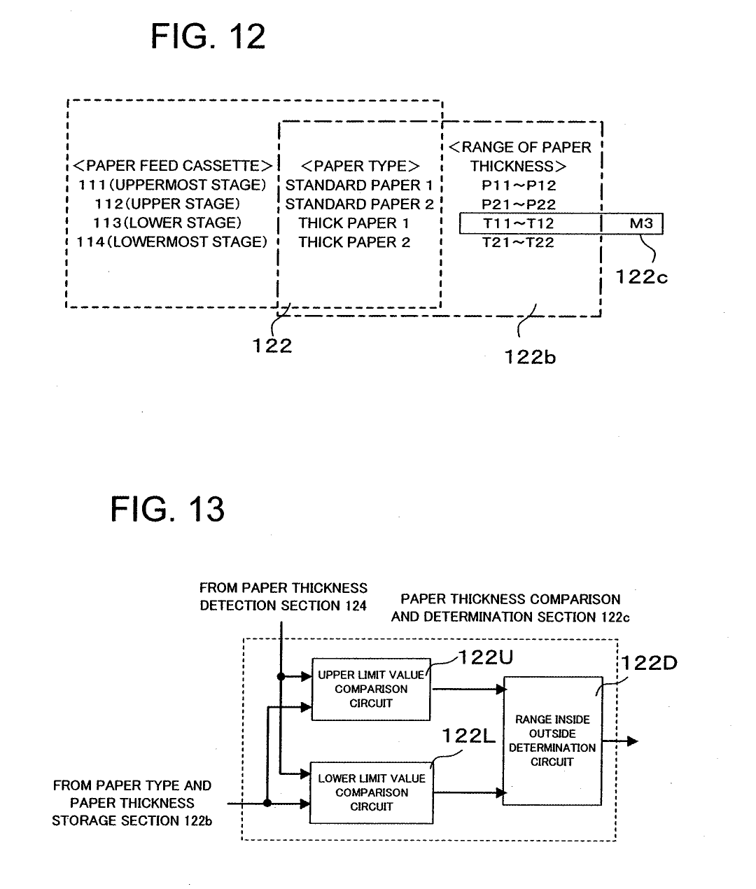

An indication “After selecting a cassette, please select a paper type and press the setting and registration button of the operation panel” is displayed on the display. In accordance with the guidance, a user touches a paper feed cassette of the main body side surface icon 118, and then touches an icon of paper type displayed on the right side to select the paper type contained in the selected paper feed cassette. By this, the paper type is displayed at each paper feed cassette position of the main body side surface icon 118. By pressing the setting and registration button of the operation panel 102, a correspondence relation between a paper feed cassette and a paper type contained in this paper feed cassette is stored in a cassette sheet correspondence recognition section 122 described later. For example, as shown in FIG. 12, the correspondence relations between the paper feed cassettes 111, 112, 113 and 114 and standard paper 1, standard paper 2, thick paper land thick paper 2 are stored in the cassette sheet correspondence recognition section 122.

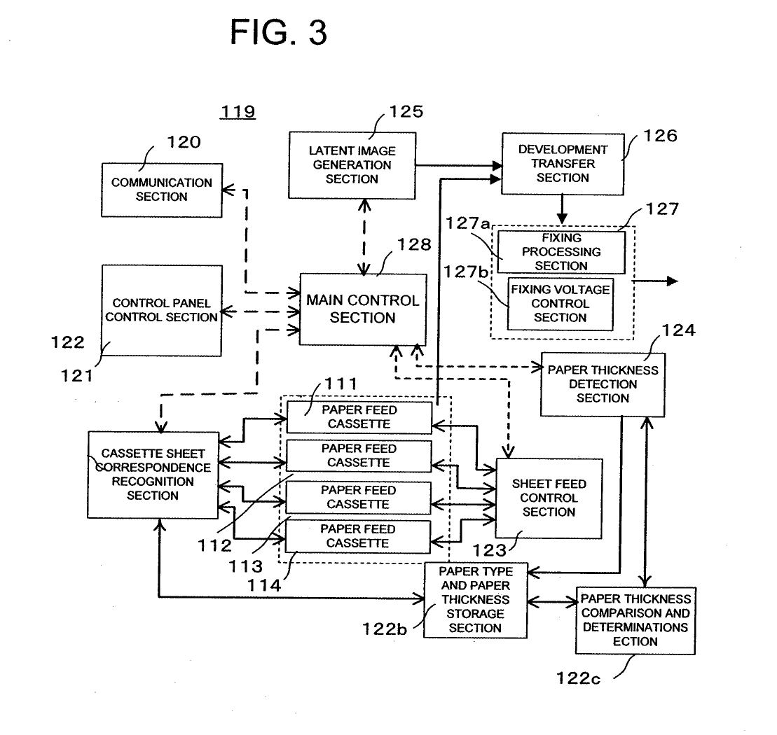

FIG. 3 shows an electrical schematic structure of the embodiment shown in FIG. 1. An MFP 119 includes a communication section 120 connected to the outside through a network, a control panel control section 121 to control the whole control panel including the operation panel 102 and the touch panel display 103 shown in FIG. 1, the cassette sheet correspondence recognition section 122 to previously recognize the paper types contained in the paper feed cassettes 111, 112, 113 and 114, a sheet feed control section 123 to feed, according to the sheet type inputted to the touch panel display 103 as described in FIG. 2, the sheet of the type, a paper thickness detection section 124 to accurately detect the thickness of the sheet fed by the sheet feed control section 123, a latent image generation section 125 to scan an original document when copying or the like is performed in the MFP 119 and to generate, for example, an electrostatic latent image, a development transfer section 126 to develop the latent image generated by the latent image generation section 125 with, for example, toner and to transfer the toner image to a specified sheet, a fixing section 127 to fix the transferred image by a specified voltage, and a main control section 128 to control the respective sections. The fixing section 127 includes a fixing processing section 127a to perform a fixing processing of an image to a specified sheet, and a fixing voltage control section 127b to control, by changing voltage, the fixing temperature when the fixing processing is performed.

The cassette sheet correspondence recognition section 122 is connected with a paper type and paper thickness storage section 122b to store the range of paper thickness corresponding to the specified paper type. Further, a paper thickness comparison and determination section 122c is connected to the paper type and paper thickness storage section 122b and the paper thickness detection section 124. The paper type and paper thickness storage section 122b stores the paper type and the range of measured value of the paper thickness of the paper type.

FIG. 13 shows an example of a circuit structure of the paper thickness comparison and determination section 122c. The paper thickness comparison and determination section 122c includes a lower limit value comparison circuit 122L to compare the measured value of paper thickness outputted from the paper thickness detection section 124 with the lower limit value of the paper type, an upper limit value comparison circuit 122U to compare the measured value of paper thickness with the upper limit value of the paper type, and a range inside outside determination circuit 122D to determine whether the measured value of paper thickness is inside the paper thickness range of the paper type. The lower limit value and the upper limit value of the paper thickness are supplied from the paper type and paper thickness storage section 122b to the lower limit value comparison circuit 122L and the upper limit value comparison circuit 122U, respectively.

For example, as shown in FIG. 12, the ranges of paper thickness measured values of the paper types of standard paper 1, standard paper 2, thick paper 1 and thick paper 2 are stored in the paper type and paper thickness storage section 122b. For example, the paper thickness of thick paper 1 is the thickness of T11 to T12. The range of thickness of the paper type stored in the paper type and paper thickness storage section 122b is updated each time the paper thickness detection section 124 measures the paper thickness. Incidentally, with respect to the initial value of the range of each paper type, according to each paper type, the density thereof is estimated and the range of paper thickness is previously determined.

In the paper thickness comparison and determination section 122c, when a specific paper type, for example, thick paper 1 is selected, it is determined whether a paper thickness value M3 measured by the paper thickness detection section 124 is within the range of T11 to T12 of the paper thickness. More specifically, in the lower limit value comparison circuit 122L, the measured paper thickness value M3 is compared with the paper thickness lower limit value T11 of thick paper 1. In the upper limit value comparison circuit 122U, the measured paper thickness value M3 is compared with the paper thickness upper limit value T12.

When the measured paper thickness value M3 is smaller than the paper thickness lower limit value T11 or is larger than the paper thickness upper limit value T12, the range inside outside determination circuit 122D determines that the measured paper thickness value M3 is outside the specified paper thickness range.

In the development transfer section 126, after the toner image is transferred to the sheet, the fixing processing of the toner image is performed in the fixing processing section 127a of the fixing section 127. The temperature of the fixing processing is controlled by the fixing voltage control section 127b. The icon P1 of standard paper 1 and the icon P2 of standard paper 2 are connected with the fixing voltage control section 127b.

When standard paper 1 is selected, the fixing voltage control section 127b controls the fixing temperature as the print condition so that the fixing temperature in the fixing section 127 falls within the range of about 150° C. to about 170° C. (first fixing temperature). On the other hand, when standard paper 2 is selected, the fixing voltage control section 127b controls the fixing temperature as the print condition so that the fixing temperature in the fixing section 127 falls within the range of about 160° C. to about 180° C. (second fixing temperature). The user reads a manual of the MFP and touches the icon of standard paper 1 or standard paper 2. When the user does not know which of them is to be selected, he/she touches the icon of standard paper (auto).

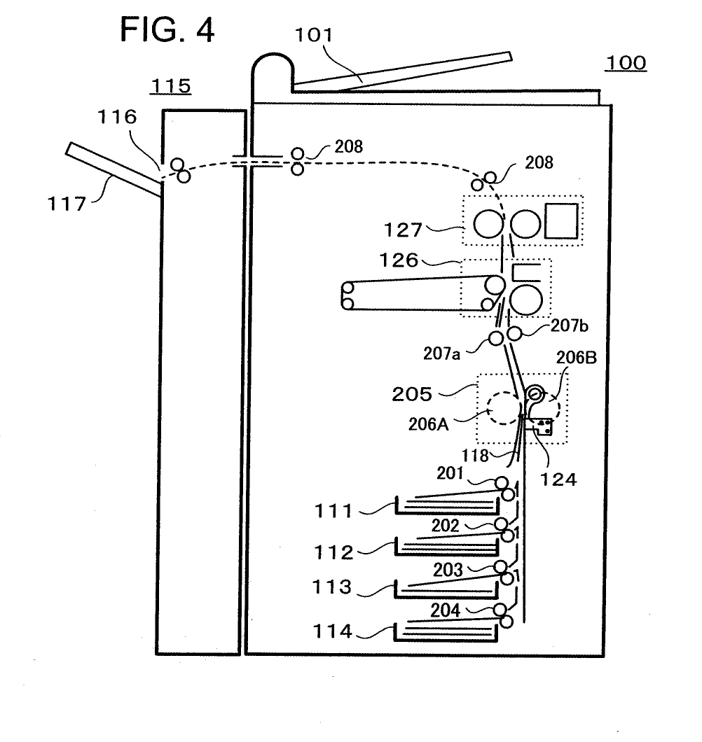

FIG. 4 shows a schematic structure of the MFP of the embodiment of the invention in which the flow of a sheet is mainly depicted.

The paper feed cassettes 111, 112, 113 and 114 contain, for example, standard paper 1, standard paper 2, thick paper 1 and thick paper 2. The sheets contained in the paper feed cassettes are selectively taken out as required one by one by paper feed rollers 201, 202, 203 and 204, and are fed to a paper thickness detection conveyance section 205. The sheet feed control section 123 shown in FIG. 3 includes a circuit to drive the paper feed rollers 201, 202, 203 and 204.

As described later, the paper thickness detection conveyance section 205 includes the paper thickness detection section 124 to detect the thickness of a conveyed sheet 118 and two pairs of conveyance rollers for conveying the sheet, that is, two conveyance drive rollers 206A and two conveyance driven rollers 206B. The sheet whose thickness is detected by the paper thickness detection section 124 of the paper thickness detection conveyance section 205 is conveyed, and is aligned by a pair of register rollers 207a and 207b. The sheet aligned by the register rollers 207a and 207b is fed to the development transfer section 126. An electrostatic latent image generated in the latent image generation section 125 shown in FIG. 3 is developed with toner in the development transfer section 126, and is transferred to the conveyed sheet.

The sheet on which the toner image is transferred is subjected to the fixing processing of the image in the fixing section 127, that is, printing is performed. The printed sheet is discharged from the apparatus main body 100 through some pairs of conveyance rollers 208, and enters the finisher 115. The sheet entering the finisher 115 is subjected to various finishing processes (not shown) such as stapling in the finisher 115, is discharged from the sheet discharge port 116, and is stacked on the stack tray 117.

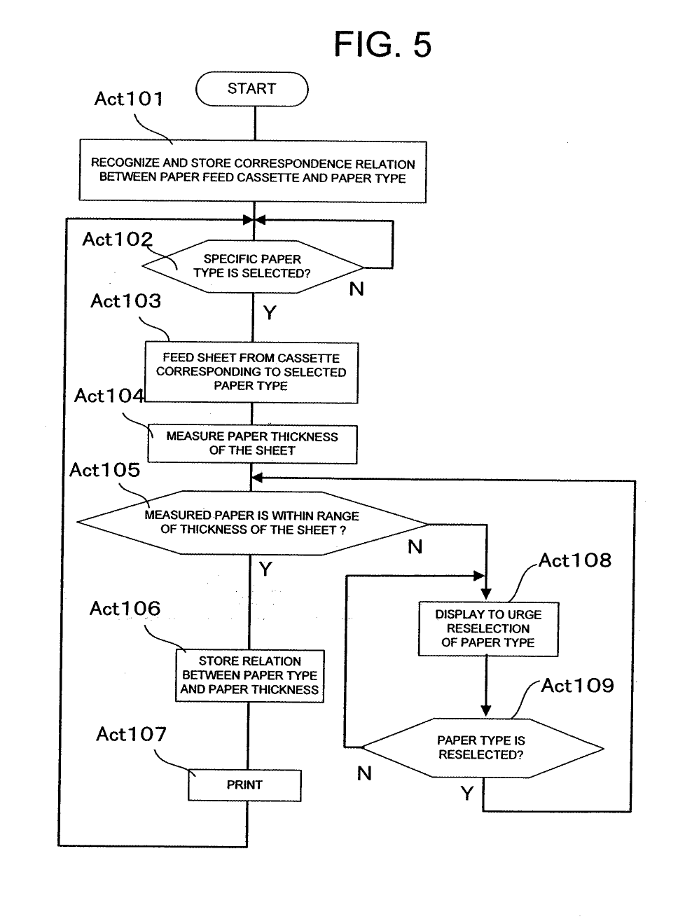

FIG. 5 shows a flowchart of an operation of the embodiment of the MFP of the invention. Act 101 of FIG. 5 is a process described with reference to FIG. 2, and at Act 101, the correspondence relations between the paper feed cassettes 111, 112, 113 and 114 and the paper types contained in these are previously recognized by the cassette sheet correspondence recognition section 122 shown in FIG. 3 and stored by the user's operation. As shown in FIG. 12, for example, the relations between the paper feed cassette 111 and standard paper 1, between the paper feed cassette 112 and standard paper 2, between the paper feed cassette 113 and thick paper 1, and between the paper feed cassette 114 and thick paper 2 are recognized and stored in the cassette sheet correspondence recognition section 122. The relation between the paper type and the paper thickness range of the paper type is stored in the paper type and paper thickness storage section 122b. The paper thickness comparison and determination section 122c performs comparison determination as to whether the paper thickness measured by the paper thickness detection section 124 is within the range of paper thickness stored in the paper type and paper thickness storage section 122b.

At next Act 102, it is detected whether a specific paper type is selected. The selection of the paper type is performed by touching the icon representing the paper type on the screen of the touch panel display 103 shown in FIG. 2. At this Act 102, when it is detected that the user directly touches an icon indicating a paper type, that is, a specific icon other than standard paper (auto), a shift is made to Act 103.

When the user touches the icon of standard paper (auto), in general, the paper thickness detection section 124 detects the paper thickness, and determines that the paper type is standard paper 1 or standard paper 2. In this embodiment of the invention, by comparison between the selected paper type and the measured paper thickness, it is confirmed whether the selected paper type conforms with the measured paper thickness. Accordingly, it is premised that a specific paper type is selected, that is, in the case of standard paper, standard paper 1 or standard paper 2 is selected. Of course, standard paper (auto) can also be selected. In this case, the paper thickness is usually measured and standard paper 1 or standard paper 2 is automatically selected, and therefore, the determination from the paper thickness in this embodiment is not performed as to determine whether the paper type conforms with the measured paper thickness.

At Act 103, the sheet feed control section 123 feeds the sheet fed from the paper feed cassette corresponding to the paper type selected as described above. At next Act 104, the paper thickness detection section 124 measures the paper thickness of the sheet.

Here, in the apparatus of this embodiment of the invention, the automatic detection of paper thickness by the paper thickness detection section 124 of the paper thickness detection conveyance section 205 shown in FIG. 4 will be described in detail.

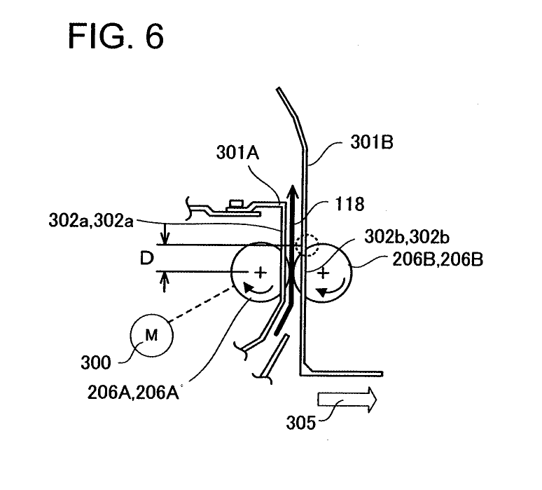

FIG. 6 shows a sectional structure of the paper thickness detection conveyance section 205. The conveyance drive roller 206A is a roller at least the peripheral surface of which is made of, for example, rubber, and is rotated and driven by a conveyance drive motor 300. The peripheral surface of a conveyance driven roller 206B is made of, for example, plastic and is rotated in accordance with the rotation of the conveyance drive roller 206A.

The sheet passes through between a conveyance guide 301A and a conveyance guide 301B. Roughly speaking, the conveyance guide 301A has an inverted C-shaped section, and the conveyance guide 301B has an L-shaped section. The sheet 118 is conveyed upward by the conveyance rollers 206A and 206A and the conveyance driven rollers 206B and 206B. The conveyance guide 301B is constructed to be movable in the lateral direction, that is, in the direction of an arrow 305, so that the sheet 118 can be easily removed when the jam occurs halfway.

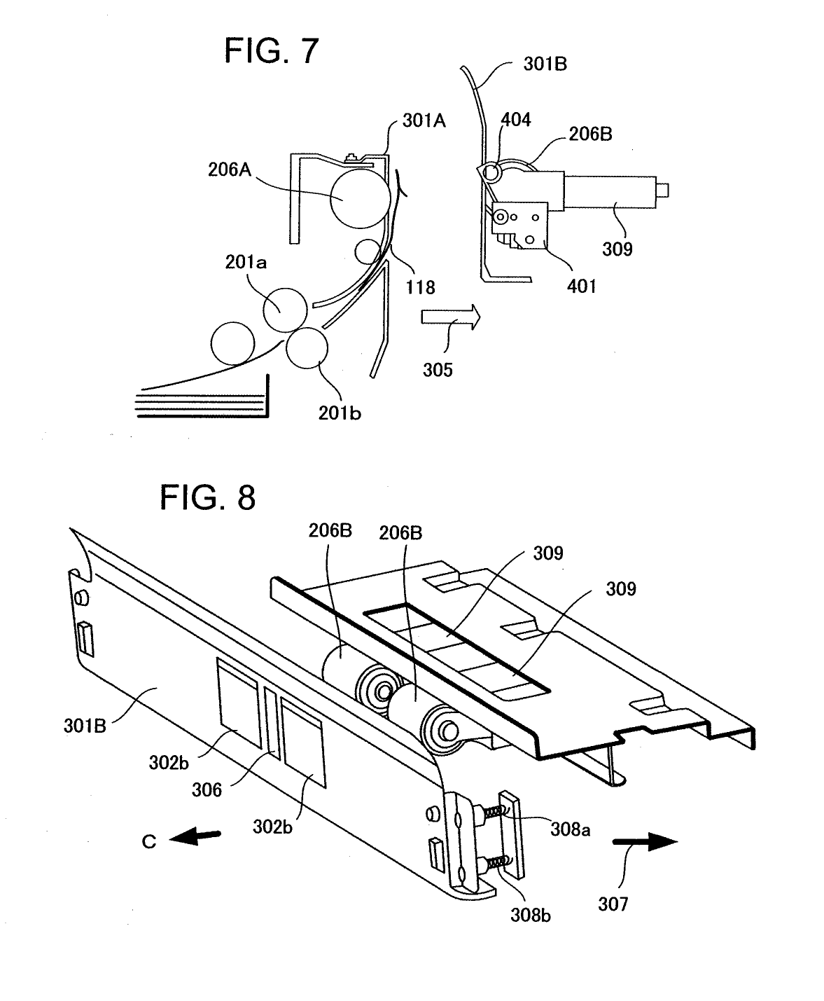

FIG. 7 is a sectional view of a state where the conveyance guide 301B and the conveyance driven rollers 206B and 206B are separated from the conveyance guide 301A and the conveyance drive rollers 206A and 206A. Further, FIG. 8 is a perspective view showing a state where the conveyance driven rollers 206B and 206B are separated in the lateral direction from the conveyance guide 301B.

The conveyance guide 301A is provided with openings 302a and 302a, and the conveyance guide 301B is provided with openings 302b and 302b. The conveyance drive rollers 206A and 206A contact with the conveyance driven rollers 206B and 206B through the openings 302a and 302a and the openings 302b and 302b. When the sheet 118 is fed from the paper feed cassettes 111 to 114, the sheet is nipped between the conveyance drive rollers 206A and 206A and the conveyance driven rollers 206B and 206B and is conveyed in an arrow direction (upward). As described later, in the middle of the conveyance, the thickness of the sheet is detected by the paper thickness detection section 124.

An opening 306 provided between the two openings 302b and 302b of the conveyance guide 301B shown in FIG. 8 is an opening through which a bearing 404 (not shown in FIG. 7), described later, of the paper thickness detection section 124 contacts with the sheet 118.

As shown in FIG. 7, the conveyance guide 301B and the conveyance driven rollers 206B and 206B can be separated from the conveyance guide 301A and the conveyance drive rollers 206A and 206A. For example, when the sheet 118 is jammed in the vicinity of a portion between the conveyance drive rollers 206A and 206A and the conveyance driven rollers 206B and 206B, as stated above, the conveyance guides 301A and 301B are separated from each other, and the sheet can be removed.

Besides, as shown in FIG. 8, the conveyance guide 301B is attached to the main body by, for example, pressure springs 308a and 308b, and is pressed in an arrow C direction. On the other hand, the conveyance driven roller 206B and a holding mechanism 309 thereof are provided independently of the conveyance guide 301B and the like. The reason is to prevent an influence as much as possible, which is caused by transmission of vibration of the main body, described later, to the bearing 404 of the paper thickness detection section 124, from being exerted on the paper thickness detection. The holding mechanism 309 and the conveyance driven roller 206B can be moved in an arrow 307 direction.

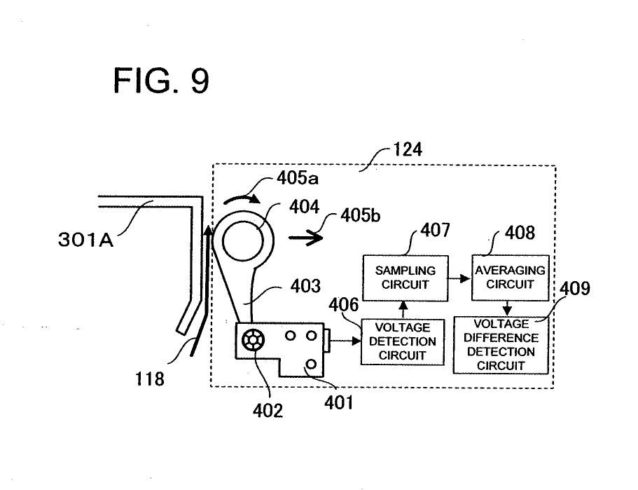

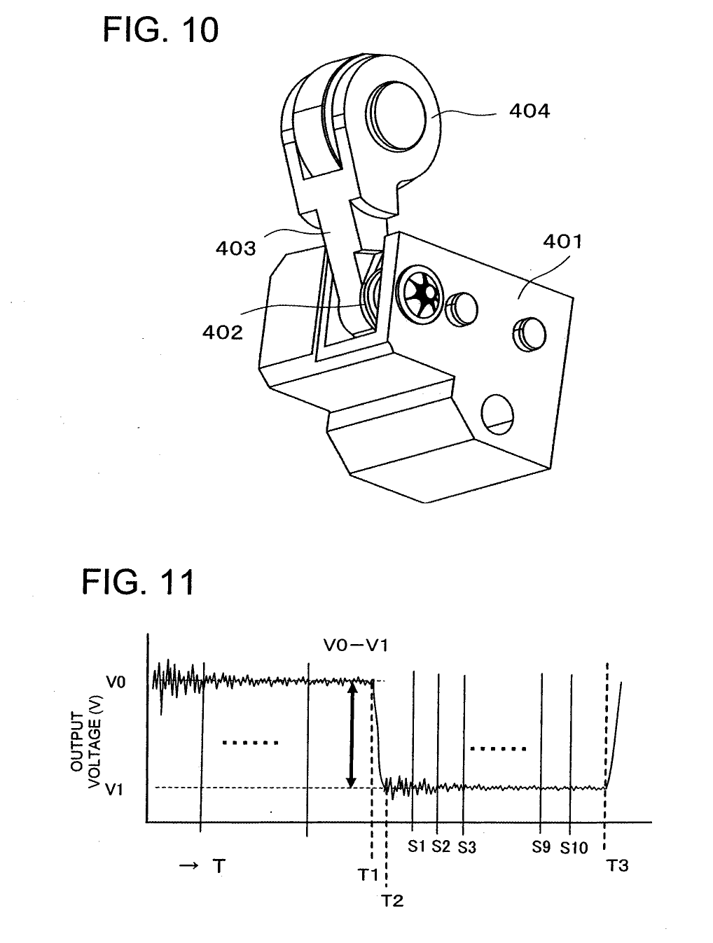

FIG. 9 shows the whole structure of the paper thickness detection section 124. The paper thickness detection section 124 includes a resistance change detection module 401, an arm 403 rotating around a fulcrum 402 of the resistance change detection module 401, a bearing 404 provided at the end of the arm 403, a voltage detection circuit 406, a sampling circuit 407, an averaging circuit 408 and a voltage difference detection circuit 409. FIG. 10 is a perspective view showing a structure of the resistance change detection module 401, the arm 403 and the bearing 404.

The bearing 404 is pressed at a specified pressure in a direction toward the conveyance guide 301A and the conveyance drive roller 206A by a not-shown spring or the like. Press load P thereof is, for example, 100 g. As shown in FIG. 6, the contact between the sheet 118 and the bearing 404 is provided at the downstream side of a nip point between the conveyance drive roller 206A and the conveyance driven roller 206B. A distance D between the nip point between the conveyance drive roller 206A and the conveyance driven roller 206B and the contact position between the sheet 118 and the bearing 404 is, for example, about 6 mm.

When the press load P is made excessively large, when the sheet 118 enters between the conveyance guide 301A and the conveyance guide 301B, the sheet 118 is not smoothly conveyed and is buckled. When the press load P is excessively small, the bearing 404 does not suitably contact with the sheet, the bearing 404 is liable to be separated from the sheet by vibration of the drive system, and the bearing 404 is separated from the sheet by shock when the sheet 118 enters. Accordingly, when the press load P is excessively small, it becomes difficult to measure the accurate thickness of the sheet.

Besides, when the distance D is excessively large, the position where the bearing 404 contacts with the sheet becomes distant from the position where the sheet 118 is conveyed and driven, that is, the contact position between the conveyance drive roller 206A and the conveyance driven roller 206B. Since the bearing 404 does not have a function of conveying the sheet 118, at the position where the bearing 404 contacts with the sheet 118 in such a state, the conveyance force of the sheet becomes low, and the normal conveyance of the sheet is liable to become difficult. As stated above, in general, there is a relation among the conveyance force of the sheet by the conveyance drive roller 206A and the conveyance driven roller 206B, the press load P of the bearing 404, and the distance D.

Accordingly, although the press load P of the bearing 404 varies by the material and structure of the bearing, the conveyance force of the sheet and the like, the press load is generally about 60 g to 140 g, and is more preferably about 80 g to 120 g. Besides, although the distance D varies by the length of the contact portion between the conveyance drive roller 206A and the conveyance driven roller 206B and the conveyance force, the distance is generally 0 mm to about 10 mm. Further, it is preferable that the distance D is within a range of about 2 mm to 8 mm.

When the sheet 118 is conveyed along the conveyance guide 301A, the bearing 404 is rotated in a direction indicated by an arrow 405a, and the arm 403 is shifted by the thickness of the sheet 118, that is, is turned a little in a direction of an arrow 405b. A magnet is provided near the fulcrum of the arm 403. A magnetic resistance sensor using magnetic resistance whose resistance value is changed correspondingly to the change of a magnetic field is provided near the magnet.

An electric signal output of the magnetic resistance sensor enters the voltage detection circuit 406, and the output voltage is sampled, for example, ten times in the sampling circuit 407. The reason why those values are sampled and averaged is that the bearing 404 is moved in the arrow 405b direction by the vibration of the apparatus and the conveyance of the sheet, so that the value of the magnetic resistance is changed and the output voltage of the voltage detection circuit 406 is changed.

The voltage values sampled by the sampling circuit 407 are averaged by the averaging circuit 408, and are inputted to the voltage difference detection circuit 409. The voltage difference detection circuit 409 detects the difference between the averaged voltage values. The voltage difference corresponds to the thickness of the sheet 118. When the sheet is conveyed, the magnetic resistance of the magnetic resistance sensor functions in the direction of reducing the resistance value, and the output voltage value of the voltage detection circuit 406 is reduced.

Setting is performed so that the voltage value detected by the voltage detection circuit 406 becomes 1 mV when the thickness of the sheet is 1 μm. In general, since the thickness of standard paper is about 100 μm, about 100 mV is detected for standard paper. For example, voltage V0 before the sheet passes is made 3.3 V, and in a normal case, when the thickness of the sheet is thick, the voltage is changed in the direction in which the voltage value is reduced while the value of about 1.35 V is made the center.

For example, it is presumed that the sheet 118 is nipped by the bearing 404 at time T1 to T2, the sheet is carried out at time T3, and the original state is returned. As shown in FIG. 11, the voltage detection circuit 406 outputs the voltage of about V0 when there is no sheet 118. Also in this state, the output value varies by the vibration of the apparatus or the like. The varying output voltage value is sampled by the sampling circuit 407, and the sampled values are averaged by the averaging circuit 408. The averaged voltage value is sent to the voltage difference detection circuit 409, and V0 is once stored as the voltage value when the sheet is not conveyed.

At time T1, the sheet 118 is conveyed, and is pinched between the bearing 404 and the conveyance guide 301A. The bearing 404 is rotated as indicated by the arrow 405a, and is turned as indicated by the arrow 405b. At this time, the value of the magnetic resistance in the magnetic resistance sensor decreases, and when time passes time T2, the output value of the voltage detection circuit 406 becomes lower than V0 as shown in FIG. 11.

Also in the state where the sheet 118 is nipped between the bearing 404 and the conveyance guide 301A and is moved, the bearing 404 is moved by the movement of the sheet 118 and the vibration of the apparatus. The output voltage value of the voltage detection circuit 406 varies by the movement of the bearing 404. These voltage values are sampled, for example, ten times by the sampling circuit 407 and are averaged by the averaging circuit 408, and the average value thereof is inputted to the voltage difference detection circuit 409 as the voltage value V1 in the state where the sheet 118 is inserted.

The voltage difference detection circuit 409 outputs, as a voltage difference, a value obtained by subtracting the voltage value V1 from the previously detected voltage value V0. This value (V0−V1) corresponds to the thickness of the sheet 118, and the thickness of the sheet 118 is detected.

As stated above, the output voltage V0 before the sheet insertion is measured before the sheet 118 is conveyed, and the output voltage V1 after the sheet insertion is measured. The voltage obtained by subtracting the output voltage V1 after the sheet insertion from the output voltage V0 before the sheet insertion, that is, the difference voltage “V0−V1” is calculated. The paper thickness substantially in a proportional relation to the difference voltage “V0−V1” is detected there from.

As stated above, when the paper thickness is detected as the difference between the voltage values, not the voltage value, the offset of the voltage can be cancelled. Besides, such a problem disappears that the voltage value is changed by the distortion of the conveyance guide or the like. Accordingly, there is a merit that the paper thickness can be further accurately measured.

Referring back to the flowchart shown in FIG. 5, at Act 105, it is detected whether the measured thickness of the sheet is within the range of the thickness of the selected paper type group. This process is performed based on the storage content of the paper type and paper thickness storage section 122b. For example, when thick paper 1 is selected at Act 102, it is detected whether the paper thickness detected by the paper thickness detection section 124 is within the range of T11 to T12 which is the thickness of thick paper 1 stored in the paper type and paper thickness storage section 122b. This detection is performed by comparing the measured paper thickness with the lower limit value T11 and the upper limit value T12 of the paper thickness.

When the thickness of thick paper 1 measured at this time is within the range of the already measured paper thickness data, at Act 106, the measured value of the thick paper 1 is sent as paper thickness data from the paper thickness detection section 124 to the paper type and paper thickness storage section 122b, and the paper type and paper thickness storage section 122b is updated.

At next Act 107, printing under the condition corresponding to the paper type, that is, latent image formation, development, transfer and fixing are performed. Then, the process returns to Act 102, and waits until the paper type is selected.

On the other hand, at Act 105, when the paper thickness of the fed sheet is outside the range of the paper thickness stored in the paper type and paper thickness storage section 122b, a notice is displayed on the screen of the touch panel display 103 shown in FIG. 2, so that the user is notified that the paper thickness is not within the range of paper thickness of the paper type, and the paper type should be selected again.

At Act 109, waiting is made until the user selects the paper type again. When the user selects the paper type, a shift is made to Act 105, and the paper thickness comparison and determination section 122c detects whether the paper thickness previously measured at Act 104 is within the range of paper thickness of the reselected paper type. Subsequently to Act 105, as described above, when the measured value of the paper type is within the range of paper thickness of the reselected paper type, at Act 106, the relation between the paper type and the paper thickness is stored in the paper type and paper thickness storage section 122b. At Act 107, printing is performed under the condition corresponding to the paper type, and the process returns to Act 102.

At Act 105, when the paper thickness measured at Act 104 is outside the paper thickness measurement range of the reselected paper type, at Act 108, the selection of the paper type is further again urged to the user. The same applies to the following.

Incidentally, when the user does not select the paper type even when the notice is given by issuing the warning to the user, it is determined without waiting for the paper type selection of the user that the paper type is the one determined by the paper thickness detection section in the apparatus, that is, the one including the measured paper thickness, and the subsequent print condition can also be set in accordance with the determined paper type. The display of urging the paper type selection is repeated against the erroneous selection of the user, and when the number of times of the repetition exceeds a specified number of times, printing may be performed under the condition determined by the paper thickness detection section.

According to the embodiment, as shown in FIG. 2, the paper type and paper thickness storage section 122b stores the paper type and the range of paper thickness of the paper type, and separately from this, the cassette sheet correspondence recognition section 122 stores the correspondence relation between the paper type and the paper feed cassette. Accordingly, there is a merit that also when the relation between the paper feed cassette and the paper type is changed, the paper type and paper thickness storage section 122b can easily set the range of paper thickness corresponding to the paper type.

In the embodiment, when the measured paper thickness value is not within the specified paper thickness range of the paper type, the notice is displayed on the screen of the touch panel display to urge the user to select the paper type again. However, in such a case, in the invention, the notice can be given to the user by another display. Alternatively, in the invention, the notice can also be given to the user by an alarm device other than the display, such as a voice.

In the embodiment, the description is given to the case where the invention is applied to the multi-function color copier. However, the invention can be applied to another image forming apparatus including an image generation section to generate an image to be printed on a recording sheet and specifying a paper type for printing, such as a normal copier, a printer or a facsimile, in addition to the multi-function color copier.

In the embodiment of the invention, the paper thickness is detected by the paper thickness detection section having the specific structure to estimate the paper type and printing is performed. However, the paper thickness is detected by an apparatus other than that, the paper type is estimated and printing may be performed.

Further, in the invention, the paper type is directly detected without detecting the paper thickness, and printing may be performed under the print condition corresponding thereto. In summary, when the paper type detection section capable of estimating the paper type or directly detecting the paper type is included, the object of the invention can be achieved.

Besides, in the embodiment of the invention, the description is given to the case where after a toner image is obtained, the toner image is transferred. However, the invention can also be applied to the case where the toner image is not transferred, but the toner image is formed on the sheet.

Besides, in the embodiment of the invention, the description is given to the case where the fixing temperature in the fixing of the transferred image is changed as the print condition. However, the invention can also be applied to the case where a print condition other than the fixing temperature is changed.

Obviously, many modifications and variations of this invention are possible in the light of the above teachings. It is therefore to be understood that within the scope of the appended claims, this invention may be practiced otherwise than as specification.

What is claimed is:

1. An image forming apparatus having a paper thickness detection section, comprising:
a paper type and paper thickness storage section to store ranges of paper thicknesses correspondingly to a plurality of paper types;
a paper thickness detection section to detect a thickness of a sheet on which a formed image is printed; and
a paper thickness comparison and determination section to feed, when a specific paper type is selected, a sheet of the paper type to the paper thickness detection section and to determine whether a measured paper thickness is within the range of paper thickness stored in the paper type and paper thickness storage section and corresponding to the paper type,
wherein when the paper thickness comparison and determination section determines that the measured paper thickness is outside the range of the selected paper type, a warning to that effect is issued.

2. The apparatus of claim 1, wherein the ranges of the paper thicknesses stored in the paper type and paper thickness storage section correspondingly to the plurality of paper types are histories of paper thicknesses measured by the paper thickness detection section correspondingly to the paper types.

3. The apparatus of claim 2, wherein the paper thickness comparison and determination section compares a lower limit value and an upper limit value of the paper thickness corresponding to the specific paper type with the paper thickness value measured by the paper thickness detection section, and determines whether the thickness of the sheet to be printed is within the range of paper thickness of the selected paper type.

4. The apparatus of claim 3, wherein the warning is given by displaying on a screen of a touch panel display on which the specific paper type is selected.

5. The apparatus of claim 4, wherein the warning is a display to urge reselection of a specific paper type on the screen of the touch panel display.

6. The apparatus of claim 5, wherein when selection is not performed in response to the display to urge the reselection of the specific paper type, a print condition is selected for the paper type corresponding to the paper thickness range including the measured paper thickness value.

7. An image forming apparatus having a paper thickness detection section, comprising:
a paper type and paper thickness storage section to store ranges of paper thicknesses correspondingly to a plurality of paper types;
a paper thickness detection section to detect a thickness of a sheet to be printed;
a paper thickness comparison and determination section to feed, when a specific paper type is selected, a sheet of the paper type to the paper thickness detection section and to determine whether the thickness of the sheet is within the range of paper thickness stored in the paper type and paper thickness storage section and corresponding to the paper type; and
a printing section to print the sheet under a print condition corresponding to the selected paper type when the paper thickness comparison and determination section determines that the thickness of the sheet is within the range of the selected paper type,
wherein when the paper thickness comparison and determination section determines that the thickness of the sheet is outside the range of the selected paper type, a warning to that effect is issued.

8. The apparatus of claim 7, wherein the ranges of the paper thicknesses stored in the paper type and paper thickness storage section correspondingly to the plurality of paper types are histories of paper thicknesses measured by the paper thickness detection section correspondingly to the paper types.

9. The apparatus of claim 8, wherein the paper thickness comparison and determination section compares a lower limit value and an upper limit value of the paper thickness corresponding to the specific paper type with the paper thickness value measured by the paper thickness detection section, and determines whether the thickness of the sheet to be printed is within the range of paper thickness of the selected paper type.

10. The apparatus of claim 9, wherein the warning is given by displaying on a screen of a touch panel display on which the specific paper type is selected.

11. The apparatus of claim 10, wherein the warning is a display to urge reselection of a specific paper type on the screen of the touch panel display.

12. The apparatus of claim 11, wherein when the selection is not performed in response to the display to urge the reselection of the specific paper type, a print condition is selected for the paper type corresponding to the paper thickness range including the measured paper thickness value.

13. An image forming apparatus having a paper thickness detection section, comprising:
a plurality of paper feed cassettes to respectively contain a plurality of kinds of sheets;
a cassette sheet correspondence recognition section to previously store correspondence relations between the plurality of paper feed cassettes and the plurality of kinds of sheets;
a paper type and paper thickness storage section to store ranges of paper thicknesses correspondingly to the plurality of kinds of sheets contained in the plurality of paper feed cassettes;
a paper thickness detection section to detect a thickness of a sheet to be printed;
a paper thickness comparison and determination section to feed, when a specific paper type is selected, a sheet from the previously set paper feed cassette corresponding to the selected paper type and to determine whether the paper thickness measured by the paper thickness detection section is within the range of paper thickness stored in the paper type and paper thickness storage section; and
a confirmation display section to request confirmation of the selected paper type when the paper thickness comparison and determination section determines that the measured paper thickness is outside the range of paper thickness of the corresponding paper type.

14. The apparatus of claim 13, wherein the ranges of the paper thicknesses stored in the paper type and paper thickness storage section correspondingly to the plurality of paper types are histories of paper thicknesses measured by the paper thickness detection section correspondingly to the paper types.

15. The apparatus of claim 14, wherein the paper thickness comparison and determination section includes a lower limit value comparison circuit to compare a lower limit value of the paper thickness corresponding to the specific paper type with the paper thickness value measured by the paper thickness detection section and an upper limit value comparison circuit to compare an upper limit value of the paper thickness corresponding to the specific paper type with the paper thickness value measured by the paper thickness detection section, and determines according to outputs of the lower limit value comparison circuit and the upper limit value comparison circuit whether the thickness of the sheet to be printed is within the range of paper thickness corresponding to the selected paper type.

16. The apparatus of claim 15, wherein the confirmation display section is a touch panel display on which the specific paper type is selected.

17. The apparatus of claim 16, wherein a display on the confirmation display section is a display to urge reselection of a specific paper type on a screen of the touch panel display.

18. A paper type confirmation method of an image forming apparatus, comprising:
storing ranges of paper thicknesses correspondingly to a plurality of paper types into a paper type and paper thickness storage section;
feeding, when a specific paper type is selected, a sheet of the paper type to a paper thickness detection section to detect a paper thickness;
determining, by a paper thickness comparison and determination section, whether the thickness of the sheet is within the range of paper thickness stored in the paper type and paper thickness storage section and corresponding to the paper type; and
printing the sheet under a print condition corresponding to the selected paper type when it is determined that the thickness of the sheet is within the range of the selected paper type, and issuing, when it is determined that the thickness of the sheet is outside the range of the selected paper type, a warning to that effect.

19. The method of claim 18, wherein the ranges of the paper thicknesses stored in the paper type and paper thickness storage section correspondingly to the plurality of paper types are histories of paper thicknesses measured by the paper thickness detection section correspondingly to the paper types.

20. The method of claim 19, wherein the paper thickness comparison and determination section compares a lower limit value and an upper limit value of the paper thickness corresponding to the specific paper type with the paper thickness value measured by the paper thickness detection section and determines whether the thickness of the sheet to be printed is within the range of paper thickness corresponding to the selected paper type.

21. The method of claim 20, wherein the warning is given by displaying on a screen of a touch panel display on which the specific paper type is selected.

22. The method of claim 21, wherein the warning is a display to urge reselection of a specific paper type on the screen of the touch panel display.

23. The method of claim 22, wherein when the selection is not performed in response to the display to urge the reselection of the specific paper type, a print condition is selected for the paper type corresponding to the paper thickness range including the measured paper thickness value.
